(19) United States
(12) Patent Application Publication
(10) Pub. No.: US 2025/0307990 A1
(43) Pub. Date: Oct. 2, 2025

(54) IMAGE PROCESSING METHOD, APPARATUS AND ELECTRONIC DEVICE

(71) Applicant: Lenovo (Beijing) Limited, Beijing (CN)

(72) Inventors: Zhou YU, Beijing (CN); Jie LIU, Beijing (CN)

(21) Appl. No.: 19/074,371

(22) Filed: Mar. 8, 2025

(30) Foreign Application Priority Data
Mar. 28, 2024 (CN) 202410370424.0

(51) Int. Cl. G06T 5/50; G06T 7/246

(52) U.S. Cl. CPC G06T 5/50; G06T 7/248; G06T 2207/20221

(57) ABSTRACT

The present disclosure describes an image processing method, apparatus and electronic device. The method includes controlling an image sensor to sequentially output first images and second images according to a predefined output rule, where the second images are images corresponding to the first images, and the first images and the second images have different resolutions; and fusing a first image with a second image corresponding to the first image to obtain a to-be-output image.

### CROSS-REFERENCE TO RELATED APPLICATION

This application claims priority to Chinese Patent Application No. 202410370424.0, filed on Mar. 28, 2024, the content of which is incorporated herein by reference in its entirety.

### TECHNICAL FIELD

The application relates to the field of information processing technology, and in particular to an image processing method, apparatus and electronic device.

### BACKGROUND

As the resolution of cameras increases, the display size also expands, which requires individual pixels to become smaller and smaller. Therefore, pixel merging technology has become the mainstream in the industry. This pixel merging technology uses a same pixel value for multiple merged pixels. After pixel merging, good photosensitivity is obtained, but the resolution is greatly affected. The resolution of a merged image is 1/n of the original image, where n is the number of merged pixels.

However, for some industries requiring relatively high resolutions, the 1/n resolution may not meet good usage conditions at all, resulting in poor performance of output images.

### SUMMARY

In view of the foregoing, the present disclosure provides an image processing method, apparatus and electronic device.

In one aspect, the disclosure provides an image processing method, and the method includes: controlling an image sensor to sequentially output first images and second images according to a predefined output rule, where the second images are images corresponding to the first images, and the first images and the second images have different resolutions; and fusing a first image with a second image corresponding to the first image to obtain a to-be-output image.

In another aspect, the disclosure provides an image processing apparatus. The apparatus includes a control module and a fusion module. The control module is configured to control an image sensor to sequentially output first images and second images according to a predefined output rule, where the second images are the images corresponding to the first images, and the first images and the second images have different resolutions. The fusion module is configured to fuse a first image with a second image corresponding to the first image to obtain a to-be-output image.

In another aspect, the disclosure further provides an electronic device, including: a memory and one or more processors. The memory stores a computer program executable by the one or more processors, and when executing the program, the one or more processors are configured to perform: controlling an image sensor to sequentially output first images and second images according to a predefined output rule, where the second images are images corresponding to the first images, and the first images and the second images have different resolutions; and fusing a first image with a second image corresponding to the first image to obtain a to-be-output image.

In another aspect, the disclosure further provides a non-transitory computer-readable storage medium having a computer program stored thereon that, when being executed, causes at least one processor to perform an image processing method as disclosed.

In another aspect, the disclosure also provides a computer program product, which includes a computer program, and when the computer program is executed by a processor, an image processing method as disclosed is implemented.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions of the embodiments of the disclosure, the drawings essential for understanding the description of the embodiments will be briefly introduced below. Apparently, the drawings described below are merely some embodiments of the disclosure. For a person skilled in the art, other drawings may be obtained based on these drawings without making creative efforts.

FIG. 1 is a flowchart of an image processing method, according to an embodiment of the disclosure;

FIG. 2 is a schematic diagram of images output by an image sensor, according to an embodiment of the disclosure;

FIG. 3 is a schematic structural diagram of an electronic device, according to an embodiment of the disclosure;

FIG. 4 is a flowchart of a method for configuring an output rule of an image sensor based at least on historical output images and a predefined configuration rule, according to an embodiment of the disclosure;

FIG. 5 is a flowchart of a method for determining whether it is necessary to configure a predefined configuration rule, according to an embodiment of the disclosure;

FIG. 6 is a flowchart of a method for controlling an image sensor to sequentially output first images and second images according to a predefined output rule, according to an embodiment of the disclosure;

FIG. 7 is a schematic diagram of a fusion of first images and second images, according to an embodiment of the disclosure;

FIG. 8 is a schematic diagram of a fusion of first images and second images, according to another embodiment of the disclosure;

FIG. 9 is a schematic diagram of a fusion of first images and second images, according to another embodiment of the disclosure;

FIG. 10 is a flowchart of a method for fusing a first image with a second image corresponding to the first image to obtain a to-be-output image, according to an embodiment of the disclosure;

FIG. 11 is a schematic diagram of a fusion of a first image and a second image, according to an embodiment of the disclosure;

FIG. 12 is a flowchart of a method for fusing a first target region in a first image and a second target region in a second image, and fusing a first non-target region in the first image and a second non-target region in the second image, to obtain a to-be-output image, according to an embodiment of the disclosure;

FIG. 13 is a flowchart of another method for fusing a first image with a second image corresponding to the first image to obtain a to-be-output image, according to an embodiment of the disclosure; and

FIG. 14 is a schematic structural diagram of an image processing apparatus according to an embodiment of the disclosure.

### DETAILED DESCRIPTION

In order to enable those skilled in the art to better understand the solutions of the disclosure, the technical solutions in the embodiments of the disclosure will be clearly and thoroughly described below in conjunction with the drawings in the embodiments of the disclosure. Apparently, the described embodiments are merely part of the embodiments of the disclosure, but not all of the embodiments. Based on the embodiments in the disclosure, other embodiments obtained by a person skilled in the art without making creative efforts are within the scope of protection of the present disclosure.

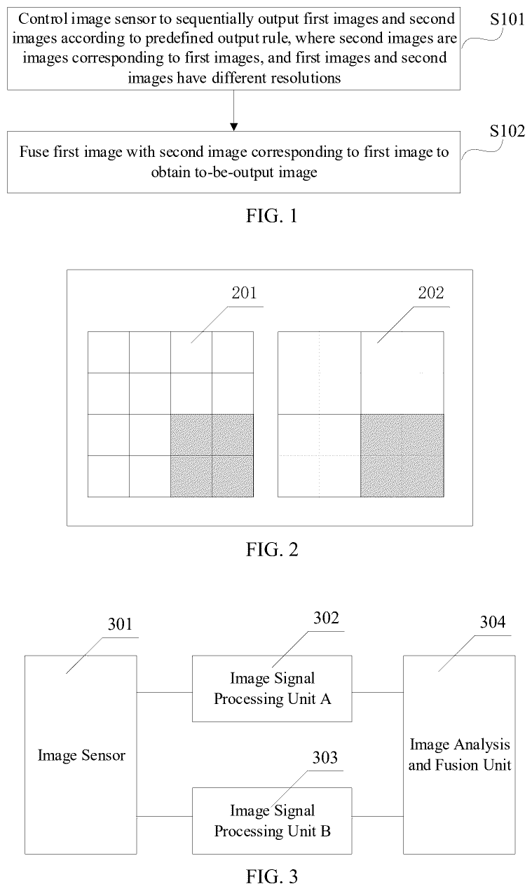

FIG. 1 is a flowchart of an image processing method, according to an embodiment of the disclosure. The method is applied to an electronic device, and the method includes the following steps.
Step S101: Control an image sensor to sequentially output first images and second images according to a predefined output rule, where the second images are images corresponding to the first images, and the first images and the second images have different resolutions.

The image sensor is an image sensor arranged in the electronic device, and the image sensor may output first images and second images with different resolutions, where the images with a higher resolution have a higher clarity, but the images with a lower resolution have a higher photosensitivity.

If the resolution of the first images is higher than that of the second images, the second images may be pixel-merged images, and the photosensitivity of the second images is better than that of the first images.

For example, a second image may be an image obtained by merging 4 pixels.

If the only difference between the first images and the second images is the resolution, the first images refer to a first image in the image sequence that may involve different contents. If the difference between the first images and the second images includes the resolution and image content, the first images and the corresponding second images may be divided into corresponding groups according to the image content.

The correspondence between the first images and the second images may be a one-to-one relationship or a one-to-many relationship. The specific correspondence between the first images and the second images is determined according to a predefined output rule.

The image sensor may output the first images and the second images alternately, and the alternation may be one frame of first image alternating with one frame of second image, one frame of first image alternating with multiple frames of second images, or multiple frames of first images alternating with one frame of second image.

In one embodiment, the rule for alternately outputting the first images and the second images is a predefined output rule, and the output rule of the image sensor may be specifically configured according to the predefined conditions.

The configuration of the predefined output rule includes at least one of the following.
Method 1: Configure the output rule of the image sensor based at least on historical output images and a predefined configuration rule.

The historical output images are images obtained before the current moment.

If the output brightness of the historical output images is lower than a target output brightness, the number of images with a lower resolution in the output rule is configured to increase. For example, when the resolution of the first images is higher than the resolution of the second images, if the output rule corresponding to the historical output images is to output one frame of first image and one frame of second image alternately, then the configured output rule may be to output one frame of first image and two frames of second images, to improve the brightness of the subsequent to-be-output images to reach the target output brightness.

If the output brightness of the historical output images is higher than the target output brightness, the configured output rule may be to increase the number of images with a higher resolution to ensure the clarity of the output images.

In one embodiment, the ratio of the first images to the second images may be determined based on the difference between the output brightness of the historical output images and the target output brightness, so that the brightness of the subsequent to-be-output images obtained by fusion reaches the target output brightness.

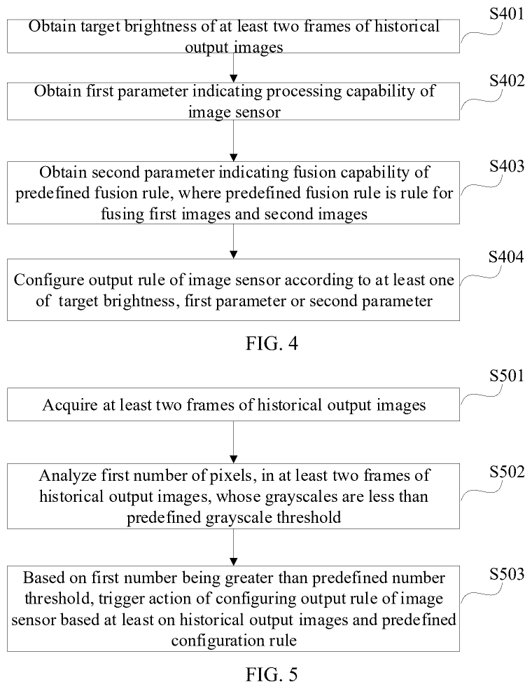

In one embodiment, in addition to the historical output images and the predefined configuration rule, the processing capability of the image sensor and the fusion capability of a predefined fusion rule need to be considered to configure the output rule of the image sensor. FIG. 4 illustrates a detailed description of the process of configuring the output rule of the image sensor.

In one embodiment, before configuring the output rule of the image sensor at least based on the historical output images and predefined configuration rule, it is also possible to pre-determine whether it is necessary to reconfigure the predefined configuration rule. FIG. 5 provides a detailed description of the process of determining whether it is necessary to reconfigure the predefined configuration rule.
Method 2: Detect ambient brightness information of the environment where the image sensor is located, and configure the output rule of the image sensor according to the ambient brightness information.

Since the ambient brightness of the image sensor may affect the capture effect of the image sensor, the higher the ambient brightness of the environment where the image sensor is located, the higher the brightness of the images acquired and output by the image sensor will be.

Therefore, in Method 2, the ambient brightness information of the environment where the image sensor is located is detected, and then the output rule of the image sensor is configured according to the ambient brightness information.

If the ambient brightness information is greater than the set ambient brightness, the ambient brightness is high enough, and the image brightness output by the image sensor for the acquired images is high. Therefore, in the output rule, the number of images with a lower resolution is configured to decrease, to improve the clarity of the to-be-output image. If the ambient brightness information is less than the set ambient brightness, in the output rule, the number of images with a lower resolution is configured to increase, to increase the photosensitivity of the to-be-output image.

FIG. 2 is a schematic diagram of images output by an image sensor, according to an embodiment of the disclosure. The output images include a first image 201 and a second image 202. The first image is an original pixel image, and the second image is a merged pixel image after pixel merging. In the figure, one square represents one pixel. Here, the pixels in the first image are composed of a 4×4 pixel matrix, and the pixel values in each pixel are different. The resolution of the first image is the maximum resolution, and the clarity is high. In the second image, the pixel form of 4 pixels in the pixel matrix is merged into 1. The dotted line in the figure represents the merging. Its resolution is ¼ of the maximum resolution. The clarity is not high, but it has improved photosensitivity.

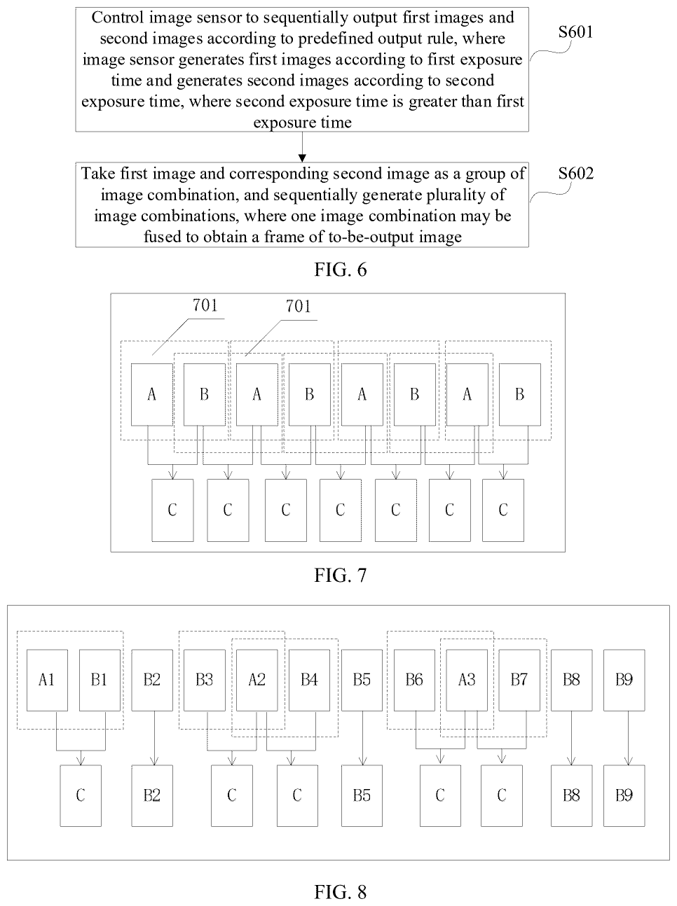

In one embodiment, when the image sensor outputs the first images and the second images, a first image and a corresponding second image may also be used as an image combination to provide a basis for subsequent fusion. The specific process of controlling the image sensor to output the first images and the second images is described in detail later in FIG. 6.
Step S102: Fuse a first image with a second image corresponding to the first image to obtain a to-be-output image.

A first image and a second image having a correspondence are fused to obtain a to-be-output image.

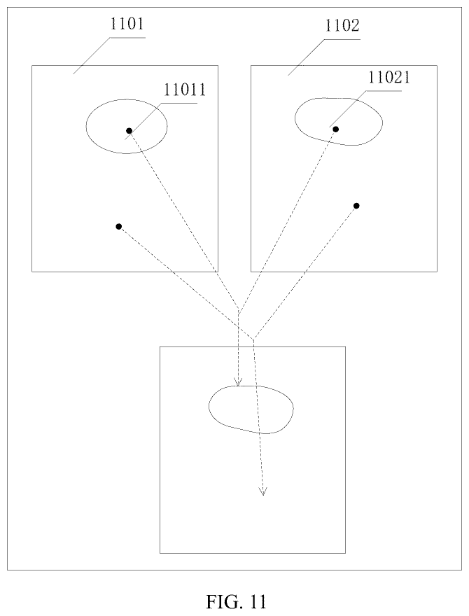

In one embodiment, corresponding regions in the first image and the second image may be fused respectively. FIG. 10 illustrates in detail a specific process of fusing the first image and the second image.

FIG. 3 is a schematic structural diagram of an electronic device, according to an embodiment of the disclosure. The electronic device has a dual signal process (SP) architecture, and includes an image sensor 301, an image signal processing unit A 302, an image signal processing unit B 303, and an image analysis and fusion unit 304. The image sensor may output two types of images with different resolutions, where the first images have a higher resolution but poor photosensitivity, and the second images have a lower resolution but better photosensitivity. The first images are original images, and the second images are merged images after pixel merging. The image processing unit A is configured to process the first images, and the first images generated by the image sensor are sent to the image processing unit A for processing. The image processing unit B is configured to process the second images, and the second images generated by the image sensor are sent to the image processing unit B for processing. The image analysis and fusion unit is configured to analyze and fuse the first images and the second images received from the image processing unit A and the image processing unit B to obtain to-be-output images.

In one embodiment, before the first images and the second images are fused, noise reduction processing is performed on the first images and the second images respectively to reduce the influence of noise in the first images and the second images to improve the image quality.

In the disclosed embodiment, the image sensor in the electronic device may output images of different resolutions. The image sensor is controlled to output the first images and the second images in sequence according to a predefined output rule, where the second images are images corresponding to the first images. The first images and the second images corresponding to the first images are fused to obtain to-be-output images. The image sensor is first controlled to output the first images and second images of different resolutions, and then a corresponding first image and second image are fused to obtain a to-be-output image. The to-be-output image is an image that may meet resolution requirements and photosensitivity requirements, etc., to ensure that the performance of the output images is improved.

FIG. 4 is a flowchart of a method for configuring the output rule of the image sensor based at least on the historical output images and the predefined configuration rule, according to an embodiment of the disclosure. The method specifically includes the following steps.
Step S401: Obtain a target brightness of at least two frames of historical output images.

The target brightness is a brightness parameter of the historical output images, which indicates the brightness of the images obtained by fusing the historical first images and the second images.
Step S402: Obtain a first parameter indicating a processing capability of the image sensor.

The first parameter indicates the processing capability of the image sensor. The stronger the processing capability of the image sensor is, the more images with the original resolution the sensor may obtain under the same conditions. Otherwise, the fewer images with the original resolution the sensor may obtain.
Step S403: Obtain a second parameter indicating a fusion capability of a predefined fusion rule, where the predefined fusion rule is a rule for fusing the first images and the second images.

The fusion capability is the computing capability of the algorithm used by the predefined fusion rule.

Under the same circumstances, if the fusion ability of the predefined fusion rule is stronger, the corresponding algorithm may fuse more first images and second images. If the fusion ability of the predefined fusion rule is weaker, the corresponding algorithm may fuse fewer first images and second images.

The specific value of the second parameter may be set according to actual conditions and is not limited in the disclosure.
Step S404: Configure an output rule of the image sensor according to at least one of the target brightness, the first parameter or the second parameter.

At least one item among the target brightness, the first parameter and the second parameter is selected as a configuration parameter to configure the output rule of the image sensor.

If the configuration parameter selects the target brightness, if the target brightness meets the condition of relatively high brightness, the number of first images with a higher resolution configured in the configuration output rule is greater than the number of second images with a lower resolution. If the target brightness meets the condition of relatively low brightness, the number of second images with a lower resolution configured in the configuration output rule is greater than the number of first images with a higher resolution.

Here, the condition of relatively high brightness may be to calculate the average value of the target brightness of the multiple frames of historical output images. If the average value is greater than a predefined upper brightness limit, it is determined that the brightness of the historical output images is relatively high, meeting the condition of relatively high brightness. If the average value is lower than a predefined lower brightness limit, it is determined that the brightness of the historical output images is relatively low, meeting the condition of relatively low brightness.

The condition of relatively high brightness may be also to calculate the number of frames, in the multiple frames of historical output images, with the target brightness greater than a predefined upper brightness limit. If the ratio of this number to the total number of frames exceeds a predefined upper threshold value, such as 90%, it is determined that the brightness of the historical output images is relatively high, and thus meets the condition of relatively high brightness. If the ratio of this number to the total number of frames is less than a predefined lower threshold value, such as 40%, it is determined that the brightness of the historical output images is relatively low, and thus meets the condition of relatively low brightness.

For example, in the fusion rule of the historical output images, the ratio of the first images to the second images is determined to be 1:1. A represents a first image, B represents a second image, then the output order is ABABAB . . . . If the output rule according to the target brightness configuration is to increase the number of first images, for example, the ratio of the first images to the second images is 2:1, then the output order is AABAABAAB . . . .

In one embodiment, the specific values of the upper brightness limit, the lower brightness limit, the upper threshold limit, the lower threshold limit, etc., may be set according to actual needs, which is not limited in the disclosure.

If the selected configuration parameter is the first parameter, if the first parameter indicates that the processing capability of the image sensor is strong, it is determined that the number of first images with a higher resolution configured in the output configuration rule is greater than the number of second images with a lower resolution. If the first parameter indicates that the processing capability of the image sensor is weak, it is determined that the number of first images with a higher resolution configured in the output configuration rule is less than the number of second images with a lower resolution.

If the selected configuration parameter is the second parameter, if the second parameter indicates that the fusion ability of the predefined fusion rule is strong, it is determined that the numbers of first images and second images in the output configuration rule are close. If the second parameter indicates that the fusion ability of the predefined fusion rule is weak, it is determined that the number difference between the first images and the second images in the output configuration rule is large.

If the selected configuration parameters include both the target brightness and the first parameter, and if the target brightness meets the condition of relatively high brightness, and the first parameter indicates that the processing capability of the image sensor is strong, the number of first images with a higher resolution configured in the configuration output rule is greater than the number of second images with a lower resolution. If the target brightness meets the condition of relatively low brightness, and the first parameter indicates that the processing capability of the image sensor is weak, the number of second images with a lower resolution configured in the configuration output rule is greater than the number of first images with a higher resolution. If the target brightness meets the condition of relatively low brightness and the first parameter indicates that the processing capability of the image sensor is strong, or the target brightness meets the condition of relatively high brightness and the first parameter indicates that the processing capability of the image sensor is weak, the specific ratio between the first images and the second images may be determined according to the specific target brightness and the specific value of the first parameter, so as to meet the processing capability of the image sensor on the premise that the brightness of the to-be-output images meets the brightness requirement.

If the selected configuration parameters include both the target brightness and the second parameter, if the target brightness meets the condition of relatively high brightness, the second parameter indicates that the fusion ability of the predefined fusion rule is relatively strong, the number of first images with a higher resolution configured in the configuration output rule is increased, the number of second images with a lower resolution is reduced, and the number of first images is greater than the number of second images, and the two numbers are close. The clarity of the output images is improved as much as possible under the premise of ensuring the brightness. If the target brightness meets the condition of relatively high brightness, and the second parameter indicates that the fusion ability of the predefined fusion rule is weak, the number of first images with a higher resolution configured in the configuration output rule is increased, the number of second images with a lower resolution is reduced, and the number of first images is greater than the number of second images, and the difference between the two numbers is large. Under the premise of the fusion ability of the predefined fusion rule, the brightness of the output images is reduced and the clarity of the output images is improved. If the target brightness meets the condition of relatively low brightness, and the second parameter indicates that the fusion ability of the predefined fusion rule is strong, the number of first images with a higher resolution configured in the configuration output rule is reduced, the number of second images with a lower resolution is increased, and the number of first images is smaller than the number of second images, and the two numbers are close. Under the premise of ensuring the brightness, the clarity of the output images is improved as much as possible. If the target brightness meets the condition of relatively low brightness, the second parameter indicates that the fusion ability of the predefined fusion rule is weak, the number of first images with a higher resolution configured in the configuration output rule is reduced, the number of second images with a lower resolution is increased, the number of first images is smaller than the number of second images, and the difference between the two numbers is large. Under the premise of the fusion ability of the predefined fusion rule, the brightness of the output images is improved to maintain the clarity of the output images.

If the selected configuration parameters include all of the target brightness, the first parameter and the second parameter, the number relationship of the first images and the second images is determined in combination with the target brightness, under the premise of considering the fusion capability of the predefined fusion rule and the image processing capability of the sensor.

If the target brightness meets the condition of relatively high brightness, the number of first images with a higher resolution configured in the configuration output rule is increased, and the number of second images with a lower resolution is reduced, and the relationship between the number of first images and the number of the second images is determined according to the fusion capability of the predefined fusion rule and the image processing capability of the sensor. If the target brightness meets the condition of relatively low brightness, the number of first images with a higher resolution configured in the configuration output rule is reduced, and the number of second images with a lower resolution is increased, and the relationship between the number of first images and the number of the second images is determined according to the fusion capability of the predefined fusion rule and the image processing capability of the sensor.

In the disclosed embodiment, a target brightness of multiple frames of historical output images, a first parameter indicating the processing capability of the image sensor, and a second parameter indicating the processing capability of a predefined fusion rule are respectively obtained. The predefined fusion rule is a rule for fusing the first images and the second images. The output rule of the image sensor is configured according to at least one of the target brightness, the first parameter, or the second parameter. The output rule of the image sensor may be determined according to the target brightness of the output images fused before the current moment and the processing capability of the image sensor that generates the images and the predefined fusion rule that processes the images, so that the brightness and clarity of the to-be-output images subsequently obtained by fusing the first images with the corresponding second images output by the image sensor are balanced, and the image quality of the to-be-output images is high.

FIG. 5 is a flowchart of a method for determining whether a predefined configuration rule needs to be reconfigured, according to an embodiment of the disclosure. The method specifically includes the following steps.
Step S501: Acquire at least two frames of historical output images.

A historical output image is a to-be-output image obtained by fusing a first image generated at a historical moment before the current moment and a second image generated at the historical moment.

The at least two frames of historical output images may be multiple frames of historical output images that are closest to the current moment.
Step S502: Analyze a first number of pixels, in the at least two frames of historical output images, whose grayscales are less than a predefined grayscale threshold.

The multiple frames of historical output images are analyzed to obtain the grayscale of each pixel therein.

Here, the grayscale of a pixel is a parameter that is positively correlated with the brightness of the image. The larger the grayscale, the greater the brightness.

The predefined grayscale threshold is a grayscale threshold corresponding to a predefined image brightness, and the predefined image brightness is a target image brightness.

The number of pixels, in each historical output image, whose grayscales is less than a predefined grayscale threshold is counted to obtain a first number.

Here, the first number may be the sum of the numbers of pixels, in the multiple frames of historical output images, whose grayscales are less than the predefined grayscale threshold, or it may be other values calculated based on the number of pixels, in each frame of historical output image, whose grayscales are less than the predefined grayscale threshold.
Step S503: Based on the first number being greater than a predefined number threshold, trigger an action of configuring the output rule of the image sensor based at least on the historical output images and the predefined configuration rule.

If the first number is greater than the predefined number threshold, it indicates that the brightness of the multiple frames of historical output images is dark, and the output rule of the image sensor needs to be reconfigured to increase the brightness of the to-be-output images and improve the image quality.

In one embodiment, if the brightness of the historical output images is too bright, it is also necessary to reconfigure the output rule of the image sensor to improve the quality of the to-be-output images.

Specifically, the number of pixels, in the multiple frames of historical output images, whose grayscales are greater than a predefined grayscale upper limit threshold may be first determined. If the number is greater than a predefined number threshold, it is determined that the brightness of the historical output images is too bright. This also triggers an action of configuring the output rule of the image sensor based at least on the historical output images and the predefined configuration rule.

In the disclosed embodiment, the grayscales of pixels in the obtained multiple frames of historical output images are analyzed to determine a first number of pixels whose grayscales meet a condition of being less than a predefined grayscale threshold. If the first number is greater than a predefined number threshold, it is determined that the brightness of the multiple frames of historical output images is dark, then it is necessary to reconfigure the output rule of the image sensor. This thus triggers an action of configuring the output rule of the image sensor based on at least the historical output images and the predefined configuration rule, so as to improve the brightness of the subsequently generated to-be-output images and improve the quality of the to-be-output images.

FIG. 6 is a flowchart of a method for controlling an image sensor to sequentially output first images and second images according to a predefined output rule, according to an embodiment of the disclosure. The method specifically includes the following steps.
Step S601: Control an image sensor to sequentially output first images and second images according to a predefined output rule, where the image sensor generates the first images according to a first exposure time and generates the second images according to a second exposure time, where the second exposure time is greater than the first exposure time.

The image sensor sequentially outputs the first images and the second images according to a predefined output rule.

Here, the image sensor generates the first images with a first exposure time, where the first exposure time is shorter, and the resolution of the first images is higher, but the photosensitivity is lower. The image sensor generates the second images with a second exposure time, where the second exposure time is longer, and the resolution of the second images is lower, but the photosensitivity is higher.

The first exposure time may be 33.3 milliseconds, the second exposure time may be 40 milliseconds, etc. The second exposure time is longer than the first exposure time, and accordingly, the frame rate of the images output by the image sensor is reduced.

Apparently, the specific values of the first exposure time and the second exposure time may be set according to actual conditions and are not limited in the disclosure.

For example, the ratio of the first images to the second images is 1:1, and the output order is one-to-one correspondence, A represents a first image, B represents a second image, and the output order is ABABAB . . . .

For example, the ratio of the first images to the second images is 1:3, then the output order is one first image and three second images, A represents a first image, B represents a second image, and the output order is ABBBABBBABBB
Step S602: Take a first image and the corresponding second image as a group of image combination, and sequentially generate a plurality of image combinations, where one image combination may be fused to obtain a frame of to-be-output image.

In the fusion process, a first image and the corresponding second image are fused. Therefore, in the disclosed embodiment, a first image and the corresponding second image that may be fused are first grouped into a group of image combination.

Each image combination includes at least one frame of first image and at least one frame of second image.

Here, two adjacent different images may be fused, specifically a first image and a second image directly adjacent thereto are combined as a group of image combination.

In order to improve the fusion effect, a first image may be also combined with a second image indirectly adjacent to it as a group of image combination.

Here, the grouping rule of image combinations may be set according to actual conditions and is not limited in the disclosure.

FIG. 7 is a schematic diagram of a fusion of the first images and the second images according to an embodiment of the disclosure, in which A represents a first image, B represents a second image, and C represents a fused to-be-output image. The first images and the second images are output alternately one by one, and the output order is ABABABAB. Each adjacent A and B, B and A are respectively regarded as a group of image combination 701. The dotted box in the figure represents a group of image combination. Each group of image combination is fused to obtain a frame of to-be-output image, and a total of 7 frames of to-be-output images are obtained.

FIG. 8 is a schematic diagram of a fusion of the first images and the second images according to another embodiment of the disclosure, in which A represents a first image, B represents a second image, and C represents a fused to-be-output image. The first images and the second images are output alternately in a ratio of 1:3, and the output order is A1B1B2B3A2B4B5B6A3B7B8B9. The schematic diagram in FIG. 8 is to fuse only the adjacent first images and second images, and a dotted box in the figure represents a group of image combination, in which A1 and B1 are fused to obtain one frame of image, A2 is fused with B3 and B4 respectively to obtain two frames of images, A3 is fused with B6 and B7 respectively to obtain two frames of images, and B2, B6, B8, and B9 are not processed and are directly output.

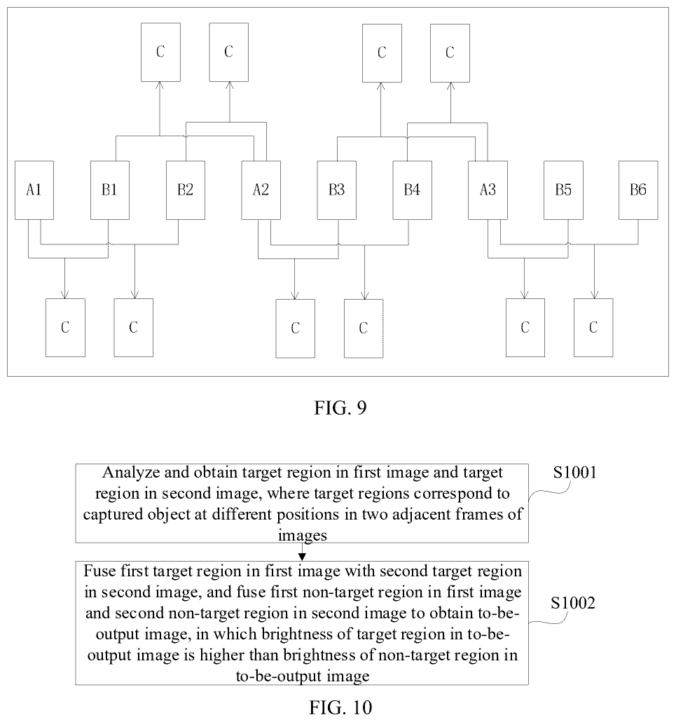

FIG. 9 is a schematic diagram of a fusion of the first images and the second images according to another embodiment of the disclosure, in which A represents a first image, B represents a second image, and C represents a fused to-be-output image. The first images and the second images are output alternately in a ratio of 1:2, and the output order is A1B1B2A2B3B4A3B5B6. The schematic diagram in FIG. 9 is to fuse a first image with a directly or indirectly adjacent second image, and A and B connected at both ends of a line segment are combined as a group of image combination. In the figure, A1 is fused with B1 and B2 respectively to obtain 2 frames of images, A2 is fused with B1, B2, B3, and B4 respectively to obtain 4 frames of images, and A3 is fused with B3, B4, B5, and B6 respectively to obtain 4 frames of images.

In the disclosed embodiment, an image sensor is controlled to output first images and second images in sequence according to a predefined output rule. The image sensor generates the first images according to a first exposure time, and the image sensor generates the second images according to a second exposure time, where the second exposure time is greater than the first exposure time. A first image and a corresponding second image are used as a group of image combination, to generate multiple image combinations in sequence. Each group of image combination may be fused to obtain a frame of to-be-output image. The image sensor generates the first images and the second images by controlling different exposure times. A first image and the corresponding second image are used as a group of image combination to provide a basis for subsequent image fusion.

FIG. 10 is a flowchart of a method for fusing a first image with a second image corresponding to the first image to obtain a to-be-output image, according to an embodiment of the disclosure. The method specifically includes the following steps.
Step S1001: Analyze and obtain a target region in a first image and a target region in a second image, where the target regions correspond to a captured object at different positions in two adjacent frames of images.

The first image and the second image are analyzed respectively to obtain the target regions corresponding to the captured object.

The position of the captured object in two adjacent frames of images is different, indicating that the position of the captured object moves during the capture process, and the captured object is in motion.

A target region is a region in an image acquired for the captured object at different capture times.

Here, the remaining region except the target region in a first image or a second image is regarded as a non-target region.

There is a certain time difference between the two frames of images generated by the image sensor. Due to the problem of rapid motion, there will be a problem of misalignment of some regions between a first image and a second image. Therefore, the algorithm for analyzing the first images and the second images for motion detection and position calibration is configured to determine the process of motion detection and position calibration for the target regions in the first images and the second images.
Step S1002: Fuse a first target region in a first image with a second target region in a second image, and fuse a first non-target region in the first image and a second non-target region in the second image to obtain a to-be-output image, in which a brightness of a target region in the to-be-output image is higher than a brightness of a non-target region in the to-be-output image.

The information of the moving captured object in the target regions is fused, and the content in the non-target regions is fused.

In one embodiment, a fusion algorithm used for fusing the first target region and the second target region is different from a fusion algorithm used for fusing the first non-target region and the second non-target region.

The display content of the first target region in the first image is fused with the display content of the second target region in the second image, so as to perform a more detailed fusion for the captured object in motion.

In one embodiment, the movement trend of the captured object may be determined based on the display content in the first target region and the display content in the second target region, and then the movement regions are fused and the non-target regions are fused, so as to separate the dominant information in the first image and the dominant information in the second image to form a new image.

FIG. 11 is a schematic diagram of a fusion of a first image and a second image according to another embodiment of the disclosure, where the first image 1101 includes a first target region 11011 and a first non-target region, and the second image 1102 includes a second target region 11021 and a second non-target region. The first target region and the second target region are fused, and the first non-target region and the second non-target region are fused to obtain a to-be-output image 1103.

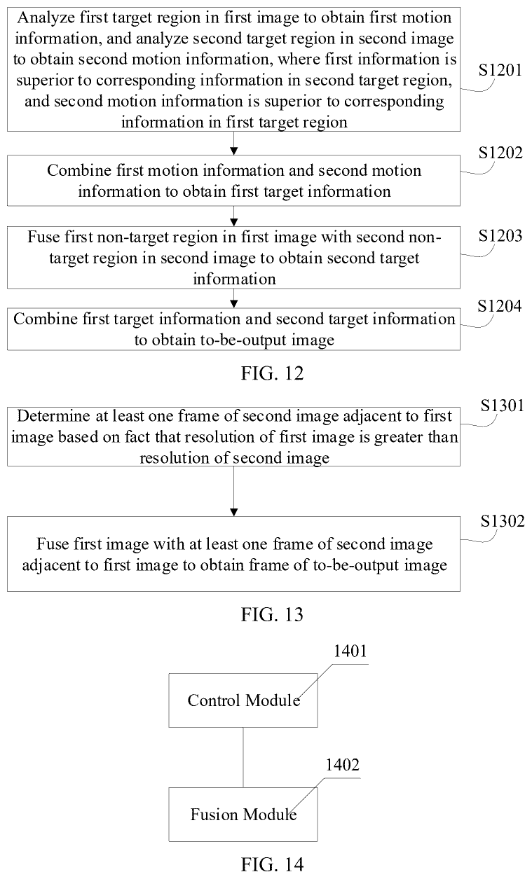

In one embodiment, the first target region and the second target region are regions corresponding to motion information. In the process of fusing the first image and the second image, the motion information needs to be considered. FIG. 12 illustrates a specific process of fusing a first target region in a first image and a second target region in a second image, and fusing a first non-target region in a first image and a second non-target region in a second image to obtain a to-be-output image.

In the disclosed embodiment, the first images and the second images are analyzed respectively to obtain the target regions therein, where a target region corresponds to a captured object that has different positions in two adjacent frames of images. A first target region in a first image and a second target region in a second image are fused, and a first non-target region in the first image and a second non-target region in the second image are fused to obtain the to-be-output image. The brightness of the target region in the to-be-output image is higher than the brightness of the non-target region in the to-be-output image. The first image and the second image are obtained when the captured object is in a moving state. The target regions of the captured object in the first image and the second image are fused, the non-target regions are fused. The dominant information in the first image and the dominant information in the second image are extracted to form a new image, so that the brightness in the target region is higher. Under the premise of ensuring the clarity of non-moving object(s) in the to-be-output image, the brightness of the moving object is higher, and the quality of the to-be-output image is higher.

FIG. 12 is a flowchart of a method for fusing a first target region in a first image and a second target region in a second image, and fusing a first non-target region in the first image and a second non-target region in the second image, to obtain a to-be-output image, according to an embodiment of the disclosure. The method specifically includes the following steps.
Step S1201: Analyze a first target region in a first image to obtain first motion information, and analyze a second target region in a second image to obtain second motion information, where the first information is superior to corresponding information in the second target region, and the second motion information is superior to corresponding information in the first target region.

The target regions in the first image and the second image are analyzed respectively to obtain corresponding motion information.

The motion information, in one image, obtained by the analysis is superior to the corresponding type of information in the other image.

For example, the captured object is a running person. In the first target region of the first image, the clarity of the upper limbs of the person is high and the clarity of the legs is low. In the second target region of the second image, the clarity of the body and legs of the person is high and the clarity of the upper limbs is low. The first motion information obtained by analysis may be the upper limb part, and the second motion information may be the body and legs.

During the specific implementation process, the first motion information and the second motion information may also be other types of information, as long as they are better than the corresponding type of information in the other frame of image.
Step S1202: Combine the first motion information and the second motion information to obtain first target information.

The first target information is a combination of the first motion information and the second motion information, which combines dominant information on the target region in the first image and dominant information on the target region in the second image.
Step S1203: Fuse a first non-target region in the first image with a second non-target region in the second image to obtain second target information.

The second target information may be obtained by directly combining the first non-target region and the second non-target region for the images.

The second target information may also be information that combines dominant information of the first non-target region and dominant information of the second non-target region. The process of determining the dominant information of the first non-target region and the dominant information of the second non-target region may refer to the aforementioned step S1201, which will not be described in detail here.
Step S1204: Combine the first target information and the second target information to obtain the to-be-output image.

The to-be-output image integrates information on the dominant target regions in the first image and the second image and information on the non-target regions in the two frames of images, and thus has higher quality than the first image and the second image alone.

In the disclosed embodiment, the first target region in the first image is analyzed to obtain the first motion information, and the second target region in the second image is analyzed to obtain the second motion information, where the first information is superior to the corresponding information in the second target region, and the second motion information is superior to the corresponding information in the first target region. The first motion information and the second motion information are combined to obtain the first target information, where the first target information is the fusion of the dominant information in the target regions in the two frames of images. The first non-target region in the first image and the second non-target region in the second image are fused to obtain the second target information. The first target information and the second target information are combined to obtain the to-be-output image. The to-be-output image combines the dominant information in the first image and the dominant information in the second image, and thus has higher quality than the first image and the second image alone.

FIG. 13 is a flowchart of another method for fusing a first image with a second image corresponding to the first image to obtain a to-be-output image, according to an embodiment of the disclosure. The method specifically includes the following steps.
Step S1301: Determine at least one frame of second image adjacent to a first image based on a fact that a resolution of the first image is greater than a resolution of the second image.

The first image and the second image have different resolutions. In one embodiment, the resolution of the first image is greater than the resolution of the second image.

The image to be fused with the first image is selected from one or two frames of second images adjacent to the first image.

Another first image adjacent to the first image is not merged with the first image.

The determination process may refer to the flowchart shown in FIG. 6.
Step S1302: Fuse the first image with the at least one frame of second image adjacent to the first image to obtain a frame of to-be-output image.

After the first image and the second image fused therewith are determined, the first image and the second image are fused to obtain a frame of to-be-output image.

If the object(s) captured by the image sensor is static, the fusion process will fuse the first image and the second image as a whole.

If an object captured by the image sensor is dynamic, the fusion process divides each of the first image and the second image into a target region and a non-target region. The target region is the region where the dynamic object is located, and different regions are fused separately.

In the disclosed embodiment, based on the fact that the resolution of the first images is greater than the resolution of the second images, at least one frame of second image adjacent to a first image is determined. The first image and the at least one frame of second image adjacent to the first image are fused to obtain a frame of to-be-output image, and the first image and the second image adjacent thereto are fused to realize the process of fusing the two frames of images. Since the two adjacent frames of images change little, fusing the two images may ensure that the eventual multiple frames of to-be-output images have better smoothness.

Corresponding to the above embodiments of image processing methods provided by the disclosure, the present disclosure also provides an embodiment of an electronic device applying the image processing methods.

FIG. 14 is a schematic structural diagram of an image processing apparatus according to an embodiment of the disclosure. The apparatus includes the following structures: a control module 1401 and a fusion module 1402.

The control module 1401 is configured to control an image sensor to sequentially output first images and second images according to a predefined output rule, where the second images are the images corresponding to the first images, and the first images and the second images have different resolutions.

The fusion module 1402 is configured to fuse a first image with a second image corresponding to the first image to obtain a to-be-output image.

Optionally, at least one of the following is further included in the image processing device.

A first configuration module, configured to configure an output rule of the image sensor based at least on historical output images and a predefined configuration rule; or a second configuration module, configured to detect the ambient brightness information of the environment where the image sensor is located and configure an output rule of the image sensor according to the ambient brightness information.

Optionally, the first configuration module includes: a first acquisition unit, configured to obtain a target brightness of at least two frames of historical output images, a second acquisition unit, configured to obtain a first parameter indicating a processing capability of the image sensor, a third acquisition unit, configured to obtain a second parameter indicating a fusion capability of a predefined fusion rule, where the predefined fusion rule is a rule for fusing a first image and a second image, and a configuration unit, configured to configure the output rule of the image sensor according to at least one of the target brightness, the first parameter or the second parameter.

Optionally, the image processing apparatus also includes an acquisition unit, configured to obtain at least two frames of historical output images before configuring the output rule of the image sensor based at least on the historical output images and the predefined configuration rule; and a first analysis unit, configured to analyze the grayscales, of a first number of pixels in the at least two frames of historical output images, that are less than a predefined grayscale threshold, and based on the first number being greater than a predefined number threshold, triggering an action of configuring the output rule of the image sensor based at least on the historical output images and the predefined configuration rule.

Optionally, the control module includes a first control unit, configured to control the image sensor to sequentially output first images and second images according to a predefined output rule; and a fusion unit, configured to fuse a first image and a corresponding second image as a group of image imagination, to sequentially generate multiple image combinations, where the image sensor generates the first images according to a first exposure time, and the image sensor generates the second images according to a second exposure time, and the second exposure time is greater than the first exposure time. One image combination may be fused to obtain a frame of to-be-output image.

Optionally, the fusion module includes a second analysis unit, configured to analyze and obtain a target region in a first image and a target region in a second image, where the target regions correspond to a captured object and have different positions in two adjacent frames of images; and a first fusion unit, configured to fuse a first target region in the first image and a second target region in the second image, and to fuse a first non-target region in the first image and a second non-target region in the second image to obtain the to-be-output image, in which the brightness of the target region in the to-be-output image is higher than the brightness of the non-target region in the to-be-output image.

Optionally, the fusion unit is specifically configured to: analyze the first target region in the first image to obtain first motion information, analyze the second target region in the second image to obtain second motion information, where the first information is superior to the corresponding information in the second target region, and the second motion information is superior to the corresponding information in the first target region; combine the first motion information and the second motion information to obtain first target information; fuse the first non-target region in the first image and the second non-target region in the second image to obtain second target information; and combine the first target information and the second target information to obtain the to-be-output image.

Optionally, the fusion module includes a determining unit, configured to determine at least one frame of second image adjacent to the first image based on a fact that the resolution of the first image is greater than the resolution of the second image; a second fusion unit, configured to fuse the first image with at least one frame of second image adjacent to the first image to obtain a frame of to-be-output image.

It should be noted that, for the functional explanation of each structure in the image processing apparatus in the disclosed embodiment, refer to the descriptions in the above method embodiments, details of which will not be repeated in the embodiment disclosed herein.

In the disclosed embodiment, the image sensor in the electronic device may output images of different resolutions. The image sensor is controlled to output first images and second images in sequence according to a predefined output rule, where the second image are images corresponding to first images. A first image and a second image corresponding to the first image are fused to obtain a to-be-output image. The image sensor is first controlled to output first images and second images of different resolutions, and then a first image and a corresponding second image are fused to obtain a to-be-output image. The to-be-output image is an image that may meet resolution requirements and photosensitivity requirements, etc., to ensure that the performance of the output images is improved.

Corresponding to the above described embodiments of image processing methods provided by the disclosure, the present disclosure also provides an electronic device, a readable storage medium and a computer program product corresponding to the image processing methods.

The electronic device includes: a memory and one or more processors, where the memory stores a computer program executable by the one or more processors, and when executing the computer program, the one or more processors are configured to perform each step of the image processing methods described elsewhere herein.

For details on how to implement the image processing methods by the electronic device, refer to the aforementioned image processing method embodiments.

The readable storage medium stores a computer program thereon, and the computer program is called and executed by a processor to implement each step of the image processing methods described elsewhere herein.

Specifically, the computer program stored in the readable storage medium is executed to implement the image processing methods, and reference may be made to the above image processing method embodiments.

The computer program product stores a computer program that, when being executed, causes at least one processor to implement each step of the image processing methods described elsewhere herein.

For details about how the computer program product executes and implements the image processing methods, refer to the above image processing method embodiments.

In this specification, each embodiment is described in a progressive manner, and each embodiment focuses on the differences from other embodiments. The same or similar parts between the embodiments may be referred to each other. For a device provided in the embodiments, since it corresponds to a method provided in the embodiment, the description is relatively simple, and the relevant parts may be referred to the method part.

The above description of the embodiments enables a person skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but will conform to the widest range consistent with the principles and novel features provided herein.

What is claimed is:

1. An image processing method, comprising:
controlling an image sensor to sequentially output first images and second images according to a predefined output rule, wherein the second images are images corresponding to the first images, and the first images and the second images have different resolutions; and
fusing a first image with a second image corresponding to the first image to obtain a to-be-output image.

2. The image processing method according to claim 1, wherein, before controlling the image sensor to sequentially output the first images and the second images according to the predefined output rule, the method further includes:
configuring an output rule of the image sensor based at least on historical output images and a predefined configuration rule; or
detecting ambient brightness information of an environment where the image sensor is located, and configuring the output rule of the image sensor according to the ambient brightness information.

3. The image processing method according to claim 2, wherein configuring the output rule of the image sensor based at least on the historical output images and the predefined configuration rule comprises:
obtaining a target brightness of at least two frames of historical output images;
obtaining a first parameter indicating a processing capability of the image sensor;
obtaining a second parameter indicating a fusion capability of a predefined fusion rule, where the predefined fusion rule is a rule for fusing the first image and the second image; and
configuring the output rule of the image sensor according to at least one of the target brightness, the first parameter, or the second parameter.

4. The image processing method according to claim 2, wherein, before configuring the output rule of the image sensor based at least on the historical output images and the predefined configuration rule, the method further includes:
obtaining at least two frames of historical output images;
analyzing grayscales, of a first number of pixels in at least two frames of historical output images, that are less than a predefined grayscale threshold; and
when the first number is greater than a predefined number threshold, triggering an action of configuring the output rule of the image sensor based at least on the historical output images and the predefined configuration rule.

5. The image processing method according to claim 1, wherein controlling the image sensor to sequentially output the first images and the second images according to the predefined output rule comprises:
controlling the image sensor to sequentially output the first images and second images according to the predefined output rule; and
taking the first image and the corresponding second image as a group of image combination, to generate multiple image combinations in sequence, wherein the image sensor generates the first image according to a first exposure time, and the image sensor generates the second image according to a second exposure time, and the second exposure time is greater than the first exposure time, and one image combination is capable of being fused to obtain a frame of to-be-output image.

6. The image processing method according to claim 1, wherein fusing the first image with the second image corresponding to the first image to obtain the to-be-output image comprises:
analyzing and obtaining a target region in the first image and a target region in the second image, wherein a captured object corresponding to the target regions have different positions in two adjacent frames of images; and
fusing a first target region in the first image with a second target region in the second image, and fusing a first non-target region in the first image with a second non-target region in the second image to obtain the to-be-output image, wherein a brightness of a target region in the to-be-output image is higher than a brightness of a non-target region in the to-be-output image.

7. The image processing method according to claim 6, wherein fusing the first target region in the first image with the second target region in the second image, and fusing the first non-target region in the first image with the second non-target region in the second image to obtain the to-be-output image comprises:
analyzing the first target region in the first image to obtain first motion information, analyzing the second target region in the second image to obtain second motion information, wherein the first motion information is superior to corresponding information in the second target region, and the second motion information is superior to corresponding information in the first target region;
combining the first motion information and the second motion information to obtain first target information;
combining the first non-target region in the first image and the second non-target region in the second image to obtain second target information; and
combining the first target information and the second target information to obtain the to-be-output image.

8. The image processing method according to claim 1, wherein fusing the first image with the second image corresponding to the first image to obtain the to-be-output image comprises:
based on a fact that a resolution of the first image is greater than a resolution of the second image, determining at least one frame of second image adjacent to the first image; and
fusing the first image with the at least one frame of second image adjacent to the first image to obtain a frame of to-be-output image.

9. An electronic device, including a memory and one or more processors, wherein the memory stores a computer program executable by the one or more processors, and when executing the computer program, the one or more processor are configured to perform:
controlling an image sensor to sequentially output first images and second images according to a predefined output rule, wherein the second images are images corresponding to the first images, and the first images and the second images have different resolutions; and
fusing a first image with a second image corresponding to the first image to obtain a to-be-output image.

10. The electronic device according to claim 9, wherein, before controlling the image sensor to sequentially output the first images and the second images according to the predefined output rule, the one or more processors are further configured to perform:
configuring an output rule of the image sensor based at least on historical output images and a predefined configuration rule; or
detecting ambient brightness information of an environment where the image sensor is located, and configuring the output rule of the image sensor according to the ambient brightness information.

11. The electronic device according to claim 10, wherein the one or more processors are further configured to perform:
obtaining a target brightness of at least two frames of historical output images;
obtaining a first parameter indicating a processing capability of the image sensor;
obtaining a second parameter indicating a fusion capability of a predefined fusion rule, where the predefined fusion rule is a rule for fusing the first image and the second image; and
configuring the output rule of the image sensor according to at least one of the target brightness, the first parameter, or the second parameter.

12. The electronic device according to claim 10, wherein, before configuring the output rule of the image sensor based at least on the historical output images and the predefined configuration rule, the one or more processors are further configured to perform:
obtaining at least two frames of historical output images;
analyzing grayscales, of a first number of pixels in at least two frames of historical output images, that are less than a predefined grayscale threshold; and
when the first number is greater than a predefined number threshold, triggering an action of configuring the output rule of the image sensor based at least on the historical output images and the predefined configuration rule.

13. The electronic device according to claim 9, wherein the one or more processors are further configured to perform:
controlling the image sensor to sequentially output the first images and second images according to the predefined output rule; and
taking the first image and the corresponding second image as a group of image combination, to generate multiple image combinations in sequence, wherein the image sensor generates the first image according to a first exposure time, and the image sensor generates the second image according to a second exposure time, and the second exposure time is greater than the first exposure time, and one image combination is capable of being fused to obtain a frame of to-be-output image.

14. The electronic device according to claim 9, wherein the one or more processors are further configured to perform:
analyzing and obtaining a target region in the first image and a target region in the second image, wherein a captured object corresponding to the target regions have different positions in two adjacent frames of images; and
fusing a first target region in the first image with a second target region in the second image, and fusing a first non-target region in the first image with a second non-target region in the second image to obtain the to-be-output image, wherein a brightness of a target region in the to-be-output image is higher than a brightness of a non-target region in the to-be-output image.

15. The electronic device according to claim 14, wherein the one or more processors are further configured to perform:
analyzing the first target region in the first image to obtain first motion information, analyzing the second target region in the second image to obtain second motion information, wherein the first motion information is superior to corresponding information in the second target region, and the second motion information is superior to corresponding information in the first target region;
combining the first motion information and the second motion information to obtain first target information;
combining the first non-target region in the first image and the second non-target region in the second image to obtain second target information; and
combining the first target information and the second target information to obtain the to-be-output image.

16. The electronic device according to claim 9, wherein the one or more processors are further configured to perform:
based on a fact that a resolution of the first image is greater than a resolution of the second image, determining at least one frame of second image adjacent to the first image; and
fusing the first image with the at least one frame of second image adjacent to the first image to obtain a frame of to-be-output image.

17. A non-transitory computer-readable storage medium, storing a computer program that, when being executed, causes at least one processor to implement an image processing method comprising:
controlling an image sensor to sequentially output first images and second images according to a predefined output rule, wherein the second images are images corresponding to the first images, and the first images and the second images have different resolutions; and
fusing a first image with a second image corresponding to the first image to obtain a to-be-output image.

18. The non-transitory computer-readable storage medium according to claim 17, wherein, before controlling the image sensor to sequentially output the first images and the second images according to the predefined output rule, the at least one processor is further configured to perform:
configuring an output rule of the image sensor based at least on historical output images and a predefined configuration rule; or
detecting ambient brightness information of an environment where the image sensor is located, and configuring the output rule of the image sensor according to the ambient brightness information.

19. The non-transitory computer-readable storage medium according to claim 18, wherein the at least one processor is further configured to perform:
obtaining a target brightness of at least two frames of historical output images;
obtaining a first parameter indicating a processing capability of the image sensor;
obtaining a second parameter indicating a fusion capability of a predefined fusion rule, where the predefined fusion rule is a rule for fusing the first image and the second image; and
configuring the output rule of the image sensor according to at least one of the target brightness, the first parameter, or the second parameter.

20. The non-transitory computer-readable storage medium according to claim 18, wherein, before configuring the output rule of the image sensor based at least on the historical output images and the predefined configuration rule, the at least one processor is further configured to perform:
obtaining at least two frames of historical output images;
analyzing grayscales, of a first number of pixels in at least two frames of historical output images, that are less than a predefined grayscale threshold; and
when the first number is greater than a predefined number threshold, triggering an action of configuring the output rule of the image sensor based at least on the historical output images and the predefined configuration rule.
